(19) United States
(12) Patent Application Publication
(10) Pub. No.: US 2010/0097985 A1
(43) Pub. Date: Apr. 22, 2010

(54) Method for Randomly Accessing a Wireless Network

(76) Inventors: Philip V. Orlik, Cambridge, MA (US); Raymond Yim, Cambridge, MA (US); Andreas F. Molisch, Pasadena, CA (US); Zhifeng Tao, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/402,459

(22) Filed: Mar. 11, 2009

Related U.S. Application Data
(60) Provisional application No. 61/106,795, filed on Oct. 20, 2008.

(51) Int. Cl. H04W 40/00

(52) U.S. Cl. 370/328

(57) ABSTRACT

In a wireless network including a base station (BS) and a set of mobile stations (MS), a MS transmits a ranging request message to the BS, using random access, when the MS enters the cell. The ranging request message includes request MS specific information for identifying the MS. The MS receives a ranging response message broadcast from the BS, which includes response MS specific information, request and response specific information to determine whether the BS received the request, or whether a collision occurred.

### FIELD OF THE INVENTION

This invention related generally to accessing wireless network, and more particularly to using a random access mechanism.

### BACKGROUND OF THE INVENTION

A network designed according to the IEEE802.16 includes a set of base stations (BSs) in cells, and each BS serves subscriber stations (SSs) in its cell. The SS are also known as mobile stations (MSs) or user equipment (UE). The stations sometimes access channels in the network randomly using code division multiple access (CDMA) in conjunction with orthogonal frequency division multiple access (OFDMA). However, there are problems with the random access as currently specified in the standard.

Initial Ranging

During initial ranging, MS transmits a ranging request including a ranging code to the BS. However, the BS cannot determine which MS transmitted the request. Therefore, in response, the BS broadcasts a ranging response including the ranging code and the identification of the OFDMA resource used by MS to transmit the ranging request. This enables the MS to identify the ranging response that corresponds to its ranging request.

Periodic Ranging

During periodic ranging, the MS selects randomly a periodic ranging code and transmits the code to the BS. Similarly to initial ranging, the BS cannot determine the MS which transmitted the CDMA ranging request. Therefore, in response, the BS broadcasts a ranging response message for the periodic ranging code, as well as the ranging time slot where the CDMA periodic ranging code has been identified. This information is used by the MS that transmitted the CDMA periodic ranging code to identify the ranging response message that corresponds to its ranging request.

Bandwidth Request

A bandwidth request (BR) code that the MS selects is modulated onto a ranging subchannel, and transmitted during the random ranging time slot. In response, the BS transmits a CDMA Allocation information element (IE), which specifies the ranging slot and ranging code that is used by the MS. This enables the MS to determine whether it has been allocated bandwidth by matching the codes.

CDMA HO Ranging

CDMA hand over (HO) ranging uses a protocol similar to initial ranging with minor optimization. However, the optimization does not change the fact that BS cannot identify the MS.

In wireless communication, only the strongest received signal, at or near the same frequency, is demodulated. When capture occurs at the BS, the MSs that contends for channel with the same ranging code and same ranging slot is more likely to be “captured” and granted access to the cell by the BS. However, the response messages, broadcast by the BS can be received by all the MSs that transmitted the code in the same ranging slot. Because the response message only contains information regarding the ranging code and the ranging slot, each of these MSs may believe that the BS has allocated resource to it, and retransmits in the uplink using the same resource. As a result, collision can occur. The current random access protocols do not leverage the capture effect, and consequently can render inefficient channel resource utilization.

Exploiting Capture Effect Through Power Boosting

Conventionally, most implementation of random multiple access communications assume that a packet is successfully received if and only if there are no concurrent transmissions. However, this collision model is a coarse and pessimistic way to model a wireless physical layer that handles interference. As long as the received power of a signal is sufficiently stronger than the interference power, the receiver can decode (capture) the stronger signal. In fact, performance improvements due to such capture models are known for ALOHA, IEEE 802.11, Bluetooth radios, and cellular networks.

Specifically, let Pᵢ denote the power received from node i.e., the ‘receive power’. The receiver can decode the packet from node i successfully if the received signal to interference and noise ratio (SINR) exceeds a threshold

$$\frac{{P}_{i}}{{\sum }_{j \neq i} {P}_{j} + {σ}^{2}} \geq \overline{γ} ,$$

where σ² is the noise power, and γ̅≧1 is a threshold that depends on the modulation and coding used for the transmission. Thus, a packet can be decoded successfully even when two or more users transmit concurrently when the power levels are sufficiently apart, otherwise, none of the packets can be captured and decoded.

Power boosting during multiple access can improve: the amount of time required transmit packets to the BS; and the efficiency of resolving contentions amongst multiple MSs. Power boosting can improve the efficiency of collision resolution by 30%. If different users have different priority levels and power, then an average of 2.1 slots are required for the user with the highest priority to transmit its message to the BS, even when fifty MSs contend.

In terms of IEEE 802.16m development, Emergency 911 calls are treated with much higher priority than other traffics. The priority can be reflected during the admission control process, and during the multiple access process using power boosting for the call establishment message. One possible implementation is to allow an E911 establishment message to be transmitted at maximum power during multiple access. Such a strategy increases the probability of capturing the E911 message even when many other MSs transmit concurrently during the E911 message.

However, to enable the fast random access protocols, one needs a mechanism for the BS to indicate the difference between a collision and successful reception of a single ranging code.

### SUMMARY OF THE INVENTION

In a wireless network including a base station (BS) and a set of mobile stations (MS), a MS transmits a ranging request message to the BS, using random access, when the MS enters the cell.

The ranging request message includes request MS specific information for identifying the MS.

The MS receives a ranging response message broadcast from the BS, which includes response MS specific information. request and response specific information to determine whether the BS received the request, or whether a collision occurred.

### BRIEF DESCRIPTION OF THE DRAWINGS

FIG. 1 is a schematic of a network according to embodiments of the invention; and

FIG. 2 is a block diagram of a ranging message according to embodiments of the invention.

### DETAILED DESCRIPTION OF THE PREFERRED EMBODIMENT

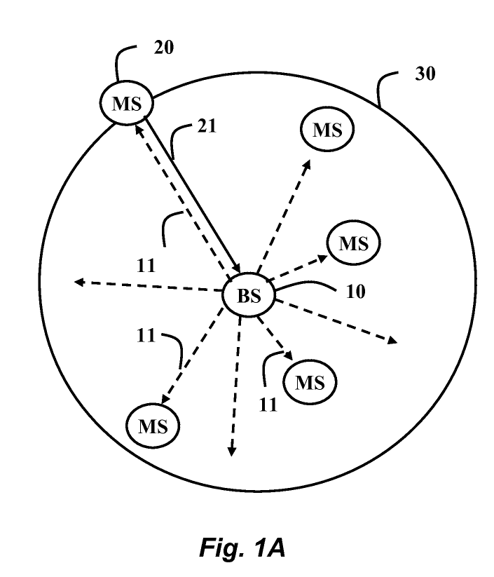

The embodiments of the invention provide a method for ranging in a network designed according to the IEEE 802.16 standard. As shown in FIG. 1A, the network includes a base station (BS) 10, and a set of mobile stations (MSs) in a cell 30. It is understood that the network can include multiple cells. When a particular MS 20 enters the cell, during initialization, ranging and bandwidth allocation is performed. Because the MS has not yet formally entered the cell, random access is used. However, as stated above random access can result in collisions. The method of the invention minimizes such collisions.

Instead of having the MS transmit only the selected ranging code to the BS, the MS transmits 21 additional bits at the end of the ranging code to include request MS specific information associated with the MS during the ranging process.

This MS specific information can be a random sequence of bits selected during the ranging, or some function of the Media Access Control (MAC) address of the MS, or other information that is generated by the MS.

As shown in FIG. 1B, this MS specific information can also include error correcting code (ECC) 105 for error identification and correction. The MS needs the capability of later recalling or deriving this request MS specific information. The packet includes a cyclic prefix (CP) 101, codes 102, the request MS specific information 103, and guard intervals 104.

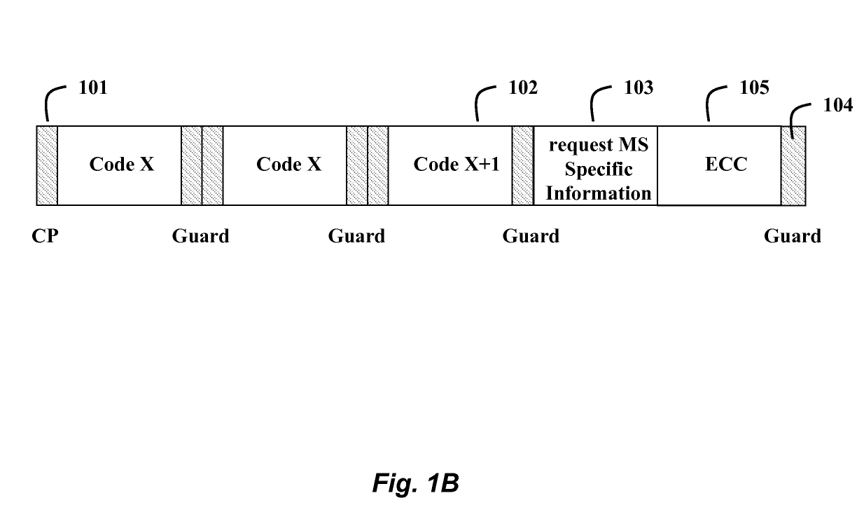

When the BS receives the ranging code, the BS de-correlates the code and examines the correlation peak to determine which CDMA code has been transmitted by the MS. After the peak is located, the BS decodes the MS specific information. The response message broadcast 11 by the BS includes the response MS specific information in addition to other information regarding the ranging code and the ranging slot. The response message is similar in structure as the request message shown in FIG. 2.

It should be noted that the specific information in response message received by the MSs is only the same for the MS that transmitted the request. Other MSs may receive a message with different information, which can be indicative of a collision.

The following cases can exist.

Case 1: The Ranging Code is Used by One MS

The BS decodes the MS specific information, and transmits this information back to the MS in the response message as response MS specific information. The MS checks the response MS specific information and can determine if it is the same as the request specific information, in which case the BS received the request message.

Case 2: The Ranging Code is Used by Multiple MSs with Capture

The MS with the highest received power is captured by the BS. The BS decodes the MS specific information of this MS, and broadcasts this information to all MSs in the response message. The MS with the highest received power receives the MS specific information, and determines that the BS indeed received its ranging or BR message. However, other MSs using the same ranging code notice different MS specific information than what they have transmitted, and determine that a collision has happened, and the grant access message of BS is not for these other MSs.

Case 3: The Ranging Code is Used by Multiple MS and No Capture

A collision results in no capture. If the MS specific sequence has error checking capability, then the BS determines that a collision due to the errors in the MS specific information following the ranging code. In that case, the BS can invoke a collision resolution procedure. Even in the case when the BS cannot find an error in the MS specific information, the BS broadcasts the response MS specific information to all MSs in the response message. All MSs find a mismatch between the MS specific information that is transmitted by the BS, and the information that they have transmitted to the BS, and a collision occurred.

Standard Changes

Fast network entry can be accomplished over a random access channel by a power splitting method, and by taking advantage of any capture effect that occurs do to the inequalities of received power among colliding messages.

The current IEEE 802.16 standard and 802.1616m proposal for a message authentication code based on universal hashing (UMAC) do not allow power splitting because it is not possible to identify when collisions on the ranging and bandwidth request channel occur. Additionally, having the BS respond to the initial ranging code transmission to indicate which MS has been received allows colliding messages of the MSs to determine that their ranging code transmission were not received by the BS.

Network Entry

Network entry is a procedure by which an MS establishes a connection with the network. The network entry has the following steps:
MS synchronizes with the BS via a synchronization channel (SCH);
MS obtains BS and network service provider (NSP) IDs, and performs network selection;
MS starts ranging process;
Authentication and registration process; and
MS enters the network and sets up service flows.

Neighbour BSs search is based on the same downlink signals as the initial network search, except some information can be provided by serving BS, e.g., neighbourhood advertising (NBR-ADV). Network re-entry for handover, idle mode exit is based on the initial network entry procedure with certain optimization procedures.

Initial ranging code transmissions include an identifier of the MS. Responses to the initial ranging code transmissions include a notification of which MS was received when multiple MSs use the same ranging slot and code.

The BS can also broadcast status bits indicating a message in a following downlink frame. The range response and bandwidth request and allocation can be linked to the corresponding bit of the status indication message to reduce overhead.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for communicating in a wireless network including a base station (BS) and a set of mobile stations (MS) located in a cell, wherein each MS includes a transmitter and a receiver, comprising the steps of:
transmitting, from a MS entering the cell to the BS using random access, a ranging request message, wherein the ranging request message includes request MS specific information identifying the MS;
receiving, in the MS, a ranging response message broadcast from the BS, wherein the ranging response message include response MS specific information; and
comparing, in the MS, whether the request and response MS specific information are identical to determine whether the BS received the ranging request message that identifies the MS transmitting the range request message.

2. The method of claim 1, wherein the network operates according an IEEE 802.16 standard.

3. The method of claim 1, wherein the request MS specific information is a random sequence of bits selected during the MS.

4. The method of claim 1, wherein the request MS specific information is a function of a Media Access Control (MAC) address of the MS.

5. The method of claim 1, wherein the specific information includes an error correcting code.

6. The method of claim 1, wherein the response message includes a ranging time slot.

7. The method of claim 1, wherein multiple MS concurrently transmit the ranging request message, and wherein the MS with a highest receive power is captured by the BS.

8. The method of claim 1, wherein the entering uses a power splitting method.

9. The method of claim 1, wherein the set of MSs receive the response MS specific information, and further comprising:
determining a collision occurred if the request and response MS specific information are different.
